(19) United States
(12) Patent Application Publication
(10) Pub. No.: US 2013/0188044 A1
(43) Pub. Date: Jul. 25, 2013

(54) INTELLIGENT MONITORING SYSTEM WITH AUTOMATIC NOTIFICATION AND INTELLIGENT MONITORING DEVICE THEREOF

(71) Applicant: Chia-Chun TSOU, New Taipei City (TW)

(72) Inventor: Chia-Chun TSOU, New Taipei City (TW)

(73) Assignee: UTECHZONE CO., LTD., New Taipei City (TW)

(21) Appl. No.: 13/353,388

(22) Filed: Jan. 19, 2012

(51) Int. Cl. H04N 7/18

(52) U.S. Cl. 348/143; 348/E07.085

(57) ABSTRACT

The present invention relates to an intelligent monitoring system with automatic notification and an intelligent monitoring device thereof. The intelligent monitoring system includes at least one intelligent monitoring device and a remote main control terminal, wherein the intelligent monitoring device includes an image acquisition unit, a sensor, an embedded system, a light unit, an uninterrupted power supply, and a wireless transmission device. The embedded system receives the signals from the image acquisition unit and the sensor to carry out the monitoring and judgment process, and then outputs the signals to the remote main control terminal via the wireless transmission device in order to transmit the signals to a portable electronic device. With the implementation of the present invention, an active monitoring process can be carried out by the intelligent monitoring device with the transmission of the monitoring results to the portable electronic device to reduce the manpower cost in monitoring.

### BACKGROUND OF THE INVENTION

1. Technical Field

The present invention relates to an intelligent monitoring system with automatic notification and an intelligent monitoring device thereof, in particular to an intelligent monitoring system with automatic notification and an intelligent monitoring device thereof.

2. Description of Related Art

At present, monitoring systems commonly applied in office buildings and security guard stations in communities must be equipped with monitoring devices at every monitored areas in office buildings and in communities so as to constantly acquire regional images of these monitored areas, and security guards are employed to watch over and check the monitored areas to judge if any abnormal events take place. In case an abnormal event happens, security guards will be summoned to the monitored spot to deal with an incident or the police and the residents are informed to come to handle the incident.

The conventional monitoring systems mainly depend on manual monitoring, and a security guard may be responsible for watching over a plurality of areas in order to cut down labor cost. However, only dependence on manual monitoring can easily result in negligence of important monitored images due to fatigue from overwork or a short time of inattention. Besides, there are more monitored areas, the corresponding cost of the installation of monitoring devices and labor cost of the employed personnel will be increased accordingly. Therefore, provision of a low cost monitoring service or even a personalized electronic monitoring service becomes impossible.

In consideration of the above cited conditions, for a large number of monitored areas, how to avoid high labor cost is one major concern, and no effective approach to provide low cost and personalized security service is another concern. In view of the previously described requirements, the present inventor has made effort in combination of theory and practice so as to come up with a reasonable and effective resolution.

### SUMMARY OF THE INVENTION

The present invention relates to an intelligent monitoring system with automatic notification, and comprises: at least an intelligent monitoring device and a remote main control terminal The intelligent monitoring device comprises a sensor, an image acquisition unit, an embedded system, a light unit, an uninterrupted power supply, and a wireless transmission device. The object of the present invention is to carry out active monitoring by means of the intelligent monitoring device and instantly transmit the monitored states to portable electronic devices via the internet so as to effectively cut down the labor cost.

The present invention provides an intelligent monitoring system with automatic notification comprising: at least an intelligent monitoring device which comprises: an image acquisition unit for capturing external images and generating image signals; a sensor for detecting variation of a radiation energy in an environment and generating a first signal; an embedded system for reading said image signals and said first signal and performing monitoring judgments and operations so as to generate a plurality of output signals and a plurality of control signals; a light unit electrically connected to said embedded system and sending out light beam for alarm according to said control signals; an uninterrupted power supply electrically connected to said embedded system; and a wireless transmission device equipped with a lamp indication and connected in telecommunication with said embedded system for transmission of said output signals; and a remote main control terminal comprising a wireless module used to receive said output signals via internet and then to transmit said output signals to at least a portable electronic device.

The present invention provides as well an intelligent monitoring device for an intelligent monitoring system with automatic notification comprising: an image acquisition unit for capturing external images and generating image signals; a sensor for detecting variation of a radiation energy in an environment and generating a first signal; an embedded system for reading said first signal and said image signals and performing monitoring judgments and operations so as to generate a plurality of output signals and a plurality of control signals; a light unit electrically connected to said embedded system and sending out light beam for alarm according to said control signals; an uninterrupted power supply electrically connected to said embedded system; and a wireless transmission device equipped with a lamp indication and connected in telecommunication with said embedded system for transmission of said output signals.

Implementation of the present invention at least involves inventive steps as follows:

1. to make active judgments on a monitored image so as to cut down the labor cost;

2. to send out the results of the judgments according to a preset mode set by the user to the portable electronic devices so as to achieve the function of automatic alarm.

The detailed features and advantages of the present invention will be described in detail with reference to the preferred embodiment so as to enable persons skilled in the art to gain insight into the technical disclosure of the present invention, implement the present invention accordingly, and readily understand the objectives and advantages of the present invention by perusal of the contents disclosed in the specification, the claims, and the accompanying drawings.

### BRIEF DESCRIPTION OF THE DRAWINGS

FIG. 1 is an architecture chart of the intelligent monitoring system with automatic notification in one embodiment of the present invention;

FIG. 2 is a circuit block diagram of the intelligent monitoring device in one embodiment of the present invention; and

FIG. 3 is a flow chart of the recognition procedure of the variation of the image status in a particular area in one embodiment of the present invention.

### DETAILED DESCRIPTION OF THE EMBODIMENTS OF THE INVENTION

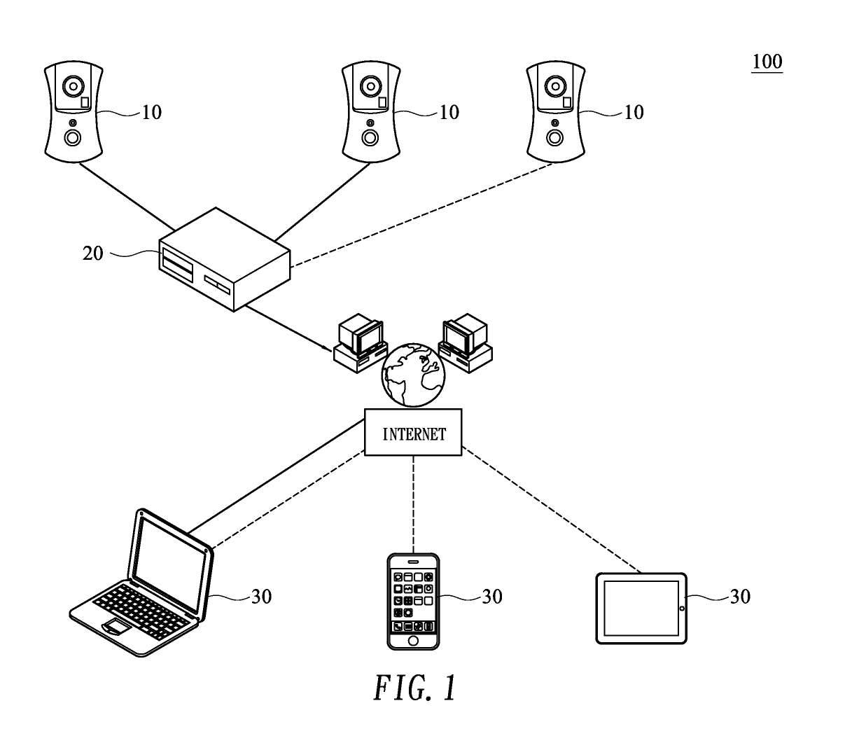

Referring to FIG. 1, the embodiment of the intelligent monitoring system with automatic notification 100 of the present invention comprises at least an intelligent monitoring device 10 and a remote main control terminal 20. The intelligent monitoring device 10 is employed to capture images of a monitored area and carry out monitoring judgments so as to produce output signals which are transmitted to the remote main control terminal 20. Afterwards, the remote main control terminal 20 will automatically transmit the output signals via internet according to a user's preset mode to a portable electronic device 30 to achieve automatic notification. The respective components of the intelligent monitoring device 10 are described in details as follows.

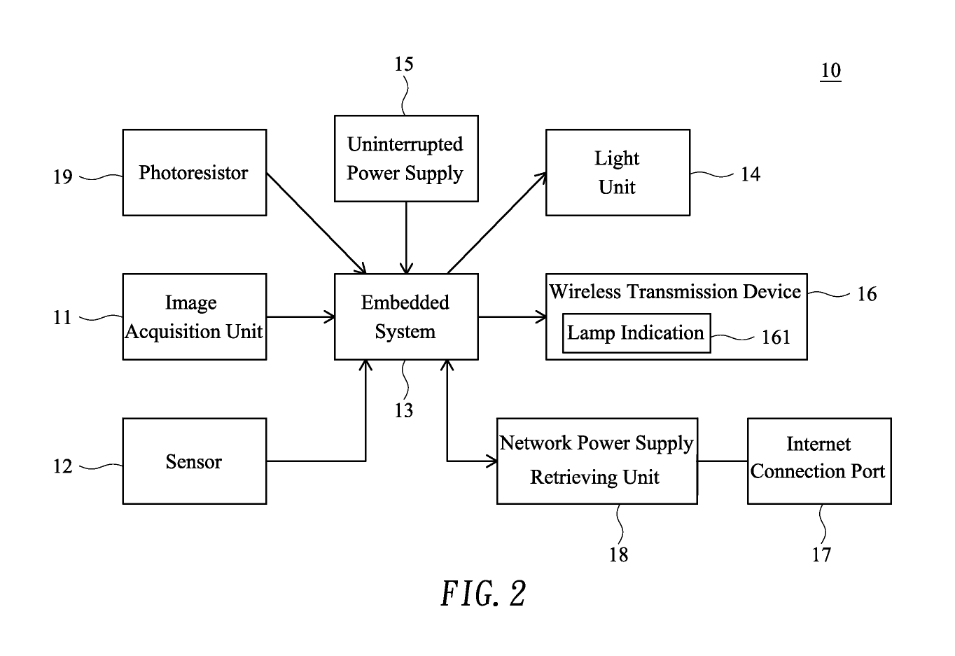

Referring to FIG. 2, the intelligent monitoring device 10 comprises an image acquisition unit 11, a sensor 12, an embedded system 13, a light unit 14, an uninterrupted power supply 15, and a wireless transmission device 16.

The image acquisition unit 11 is responsible for capturing images in the monitored area in association with the intelligent monitoring device 10 and generating image signals. The image acquisition unit 11 can be a CCD image acquisition means and operate in a low powered stand-by mode so as to save electric power consumption and can also operate in a normal mode so as to take images with a better resolution.

The sensor 12 functions to detect and monitor the variation of radiation energy in the environment of the monitored area due to the activity of a living specimen therein and generate a first signal wherein the sensor 12 can be an infrared heat sensor.

The embedded system 13 in telecommunication with the image acquisition unit 11 and the sensor 12, receives the image signals output from the image acquisition unit 11 as well as the first signal transmitted from the sensor 12. The image signals can be used to carry out a monitor judgment by way of the embedded system 13 so as to generate a plurality of output signals, and the first signal is processed by the embedded system 13 to produce a plurality of control signals as well.

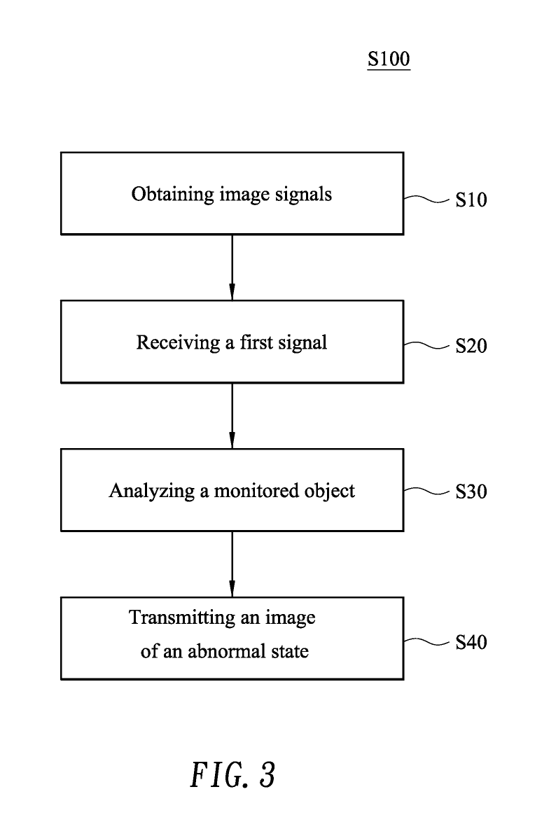

As shown in FIG. 3, the embedded system 13 can carry out monitoring judgments and operations on images taken in a particular area under surveillance, which is also named monitored area. For instance, after a recognition procedure of the variation of the image status, an alarm output signal based on judgment logic is then generated. The recognition procedure (step S100) of the variation of the image status includes the following steps: obtaining image signals (step S10); receiving a first signal (step S20); analyzing a monitored object (step S30); and transmitting an image of an abnormal state (step S40).

At first, the embedded system 13 acquires an image taken in a particular area by the image acquisition unit 11 and then transforms the same into image signals (step S10). Since the sensor 12 detecting an appearance of an object will send out a first signal. With the embedded system 13 receiving the first signal (step S20), the intrusion of the object into the monitored area is then assured, and an analysis of the object is followed in the next step (step S30).

The embedded system 13 will carry out the image recognition process so as to identify the position of the object and conduct an activity analysis on the object in the continuing images to make sure if there is an abnormal activity. For instance, by means of the image difference recognition method, the recognition of an object outside of a door is first made and then the recognition of the object inside of a door is acquired afterwards, thus the intrusion of the object is confirmed accordingly. At last, the embedded system 13 sends out an image of an abnormal state (step S40) according to a user's presetting. For example, as the intrusion of an object is identified, the embedded system 13 then transmits an output signal including the image of the intrusion of the object to provide an instant monitoring for a user.

In the process of the recognition process of the variation of the image status, if the recognized object has no variation detected at all, then the embedded system 13 controls the image acquisition unit 11 to operate in a low powered standby mode to capture images with lower resolution. Once any variation detected in the recognized object, the embedded system 13 will operate in a normal mode to take images with higher resolution so as to obtain the best monitoring effect.

As illustrated in FIG. 2, the light unit 14 is electrically connected to the embedded system 13 and receives control signals transmitted from the embedded system 13 to send out light beam for alarm according to the control signals to warn an intruder.

The uninterrupted power supply 15 electrically connected to the embedded system 13 provides the embedded system 13 with its necessary electric power so as to enable the intelligent monitoring device 10 to perform monitoring function even in a situation without a fixed power supply.

The wireless transmission device 16 in telecommunication with the embedded system 13 is responsible for the transmission of the output signal obtained from the embedded system 13 as a result of performing the corresponding monitoring judgments and operations. The wireless transmission device 16 can transmit output signals by way of Wi-Fi wireless transmission or mobile phone wireless transmission. Moreover, the wireless transmission device 16 is equipped with a lamp indication 161 which can indicate the state of the connection to a wireless network or offer the state of the transmission of output signals so that a user can be well informed of either the state of connection or the state of transmission by means of the lamp indication 161.

The intelligent monitoring device 10 can further comprises a network connection port 17 which is in telecommunication with the embedded system 13 so as to enable the intelligent monitoring device 10 to be in wired connection to a network whereby the embedded system 13 can transmit output signals via the wired network as well. Moreover, the intelligent monitoring device 10 can be further equipped with a network power supply retrieving unit 18 having its input end electrically coupled to the network connection port 17 so as to supply electric power to the intelligent monitoring device 10 and at the same time to provide electric storage power to the uninterrupted power supply 15.

The intelligent monitoring device 10 can be further provided with a photoresistor 19 which is electrically connected to the embedded system 13 for detecting an environmental light. As an object comes close to the intelligent monitoring device 10, the photoresistor 19 will detect the abatement of the environmental light so as to make the photoresistor 19 output a second signal to the embedded system 13 to activate the embedded system 13 to produce a corresponding control signal to turn on or off the light unit 14.

Referring to FIG. 1 and FIG. 2, the remote main control terminal 20 comprises a wireless module which can receive the output signals transmitted either from the wireless transmission device 16 or the network connection port 17 by way of the network and then transmits the output signals to at least a portable electronic device 30 according to a user's personalized presetting. Thereby the user can directly monitor on a display screen of the portable electronic device 30. The portable electronic device 30 can be a mobile phone, an Notebook computer, or tablet PC.

The intelligent monitoring device 10 of the present embodiment can directly carry out active monitoring judgments and transmit the monitoring result to the remote main control terminal 20 which can transmit the result to various portable electronic devices 30 according to various modes preset by a user, for instance, to a cell phone of a security guard, or to a computer of a police station so as to obtain an integrated security function.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. An intelligent monitoring system with automatic notification comprising:
at least an intelligent monitoring device which comprises:
an image acquisition unit for capturing external images and generating image signals;
a sensor for detecting variation of a radiation energy in an environment and generating a first signal;
an embedded system for reading said image signals and said first signal and performing monitoring judgments and operations so as to generate a plurality of output signals and a plurality of control signals;
a light unit electrically connected to said embedded system and sending out light beam for alarm according to said control signals;
an uninterrupted power supply electrically connected to said embedded system; and
a wireless transmission device equipped with a lamp indication and connected in telecommunication with said embedded system for transmission of said output signals; and
a remote main control terminal comprising a wireless module used to receive said output signals via internet and then to transmit said output signals to at least a portable electronic device.

2. The intelligent monitoring system with automatic notification as claimed in claim 1, wherein said embedded system performs a recognition procedure on the variation of the image status in a particular area so as to generate alarm output signals.

3. The intelligent monitoring system with automatic notification as claimed in claim 1, wherein said intelligent monitoring device further comprises a network connection port connected in telecommunication with said embedded system.

4. The intelligent monitoring system with automatic notification as claimed in claim 3, wherein said intelligent monitoring device further comprises a network power supply retrieving unit having an input end electrically connected to said network connection port and supplying electric power to said intelligent monitoring device.

5. The intelligent monitoring system with automatic notification as claimed in claim 1, wherein said intelligent monitoring device further comprises a photoresistor electrically connected to said embedded system, said photoresistor functions to detect an environmental light and outputs a second signal to said embedded system to controllably turn on/off said light unit.

6. An intelligent monitoring device for an intelligent monitoring system with automatic notification comprising:
an image acquisition unit for capturing external images and generating image signals;
a sensor for detecting variation of a radiation energy in an environment and generating a first signal;
an embedded system for reading said first signal and said image signals and performing monitoring judgments and operations so as to generate a plurality of output signals and a plurality of control signals;
a light unit electrically connected to said embedded system and sending out light beam for alarm according to said control signals;
an uninterrupted power supply electrically connected to said embedded system; and
a wireless transmission device equipped with a lamp indication and connected in telecommunication with said embedded system for transmission of said output signals.

7. The intelligent monitoring device as claimed in claim 6, wherein said embedded system performs a recognition procedure on the variation of the image status in a particular area so as to generate alarm output signals.

8. The intelligent monitoring device as claimed in claim 6, further comprising a network connection port connected in telecommunication with said embedded system.

9. The intelligent monitoring device as claimed in claim 8, further comprising a network power supply retrieving unit having an input end electrically connected to said network connection port and supplying electric power to said intelligent monitoring device.

10. The intelligent monitoring device as claimed in claim 6, further comprising a photoresistor electrically connected to said embedded system, said photoresistor functions to detect an environmental light and outputs a second signal to said embedded system to controllably turn on/off said light unit.
